(19) United States
(12) Patent Application Publication
(10) Pub. No.: US 2012/0323617 A1
(43) Pub. Date: Dec. 20, 2012

(54) PROCESSING OF BUSINESS EVENT DATA TO DETERMINE BUSINESS STATES

(75) Inventor: Johannes Papst, Walldorf (DE)

(73) Assignee: SAP AG, Walldorf (DE)

(21) Appl. No.: 13/161,253

(22) Filed: Jun. 15, 2011

(51) Int. Cl. G06Q 10/00

(52) U.S. Cl. 705/7.11

(57) ABSTRACT

The present description refers to a computer implemented method, computer program product, and computer system for obtaining business event data for a business, the business event data associated with one or more items for sale by or sold by the business, determining summary rate data based on the business event data, comparing the summary rate data to one or more business patterns, and detecting a state of the business based on the comparison of the summary rate data to one or more of the business patterns.

### TECHNICAL FIELD

This description is directed generally to business event data, and in particular, to a computer-implemented method, apparatus, and computer program product for processing of business event data to determine business state.

### BACKGROUND

Business event data may include a wide variety of data related to business events for a business. For example, business event data may include data relating to order creation (e.g., number of orders received or created per day or over other time period), purchasing of materials (e.g., amount of materials purchased or obtained, or amount of materials available for use), production or manufacturing of products or items for sale (e.g., number and types of items produced or manufactured), shipping (e.g., numbers and types of products shipped) revenue or sales information (e.g., revenue or sales for a specific time period, or numbers of specific products ordered or purchased), etc. Analysis of business event data may provide valuable insights into a state of a business and its operations.

### SUMMARY

In one general aspect, a computer program product is provided. The computer program product is tangibly embodied on a computer-readable storage medium and includes executable code that, when executed, is configured to cause at least one data processing apparatus to obtain business event data for a business, the business event data being associated with one or more items for sale by or sold by the business. The executable code is further configured to cause the at least one data processing apparatus to determine summary rate data based on the business event data, compare the summary rate data to one or more business patterns, and detect a state of the business based on the comparison of the summary rate data to one or more of the business patterns.

In another general aspect, a computer implemented method is provided that includes obtaining business event data for a business, the business event data associated with one or more items for sale by or sold by the business, determining summary rate data based on the business event data, comparing the summary rate data to one or more business patterns, and detecting a state of the business based on the comparison of the summary rate data to one or more of the business patterns.

In another general aspect, an apparatus includes obtaining logic configured to obtain business event data for a business, the business event data associated with one or more items for sale by or sold by the business, determining logic configured to determine summary rate data based on the business event data, comparison logic configured to compare the summary rate data to one or more business patterns, and detection logic configured to detect a state of the business based on the comparison of the summary rate data to one or more of the business patterns.

The subject matter described in this specification can be implemented as a method or as a system or using computer program products, tangibly embodied in information carriers, such as a CD-ROM, a DVD-ROM, a semiconductor memory, and a hard disk. Such computer program products may cause a data processing apparatus to conduct one or more operations described herein.

In addition, the subject matter described herein may also be implemented as a system including a processor and a memory coupled to the processor. The memory may encode one or more programs that cause the processor to perform one or more of the method acts described in this specification.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an exemplary system in which a state of a business (or one or more business states) may be determined based on business event data.

FIG. 2 is a block diagram illustrating the processing of business event data to determine business state according to an example implementation.

FIG. 3 is a functional block diagram of computer according to an example implementation.

FIG. 4 is a diagram illustrating an example graphical representation of summary rate data.

FIG. 5 is a flow chart illustrating operation of computer 112 according to an example implementation.

### DETAILED DESCRIPTION

In the following, a detailed description of examples will be given with reference to the drawings. It should be understood that various modifications to the examples may be made. In particular, elements of one example may be combined and used in other examples to form new examples.

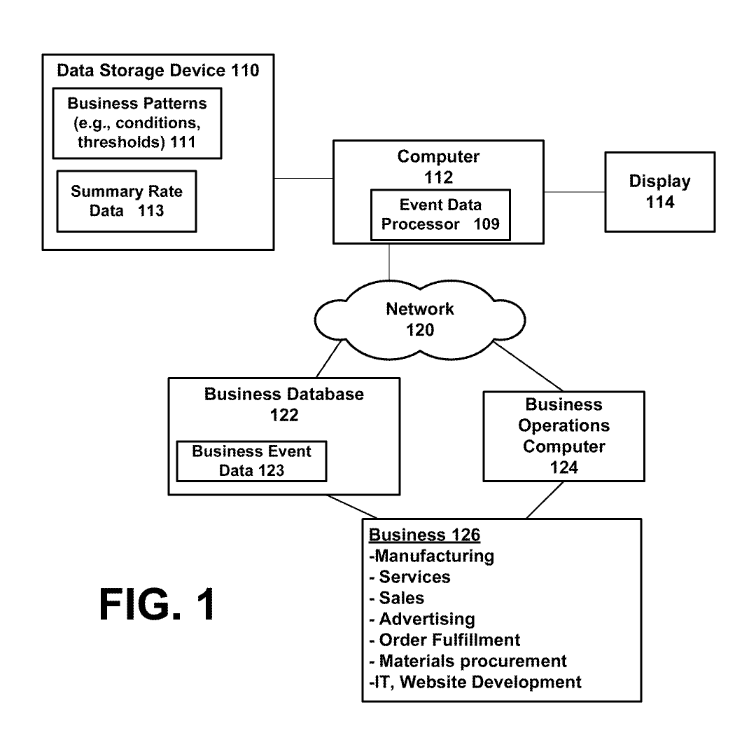

FIG. 1 is a block diagram illustrating an exemplary system in which a state of a business (or one or more business states) may be determined based on business event data. A business 126 is provided which may be any type of business, e.g., involved in the manufacturing, distribution, and/or sale of any product or device, or performing, providing, and/or selling any service, for example. In this context, the term business may include, e.g., any for-profit entity, as well as various non-profit entities, such as, for example, schools, government entities, or charities.

Various exemplary aspects of business 126 are listed in block 126 of FIG. 1, including manufacturing, services, sales, advertising, order fulfillment, materials procurement, and IT (information technology or computer services)/web development. A business operations computer 124 may be used to run or control these various aspects of the business 126. Business operations computer 124 may include any number of computers, servers and other computing devices, and may be centrally located or may be distributed at multiple locations, buildings, or sites.

Business database 122 may include one or more databases for the business that store various information for the business 126. For example, business database 122 may store business event data 123, which may include data that describes any type of business event(s), or data related to (or describing) any business activity. Business event data may be stored, for example, as one or more tables within a database (or any other data storage structure or device). By way of example, business event data may include data relating to order creation or modification, purchasing of materials (e.g., amount of materials purchased or obtained, or amount of materials available for use), production or manufacturing of products or items for sale (e.g., number and types of items produced or manufactured and/or data related to various sub-steps of a manufacturing process), shipping data (e.g., numbers and types of products shipped) revenue or sales information (e.g., revenue or sales for a specific time period, or numbers of specific products ordered or purchased), data that show numbers of creations, reads, updates and deletions (CRUDs) of database entries that reflect or record one or more business activities (e.g., sales, shipments, purchases, manufacturing details or operations, or other business activity or any status of the business), etc. These are merely some illustrative examples, and any type business event data 123 may be used.

Data storage device 110 may be any storage device, such as a server, memory (e.g., Dynamic Random Access Memory, Read Only Memory), a hard disk drive, FLASH memory, or other memory or storage device. Data storage device 110 may store computer instructions or software programs, data and other information. For example, data storage device 110 may store summary rate data 113 and business patterns 111.

Summary rate data 113 may include a summary of business event data, and may identify a rate or frequency of occurrence for business events over a period of time. For example. As one illustrative example, summary rate data 113 may include total weekly sales of product X for each week over a one year period, based on business event data of individual sales records in a database. Business patterns 111 may include, as examples, previous (or other) summary rate data (or a portion or subset thereof), conditions or thresholds, or other data indicating a business pattern or specific business activity. Other types of business patterns may be used as well, as these are merely examples.

A computer 112 may process business event data 123, among other tasks or functions. Computer 112 may include logic, e.g., in the form of hardware and/or software, which may be referred to as an event data processor 109, to perform various processing related to business events and summary rate data, as described herein. For example, computer 112 (or event data processor) may receive and transform business event data 123 to corresponding summary rate data 113. For example, to transform business event data 123 to summary rate data 113, computer 112 (or event data processor 109) may generate subtotals of business events that occurred for each of a plurality of time periods, e.g., by adding or summing the individual events that occurred within each specific time period. In this manner, computer 112 (or event data processor 109) may determine a rate or frequency of occurrence for a business event (or number of times that a business event occurred) for or during each specific time period. Alternatively, mathematical techniques may be used (by computer 112 or event data processor 109) to convert time domain (or numbers provided in the time domain) to frequency domain numbers, such as a Fourier Transform or Fast Fourier Transform (FFT) or other time domain to frequency domain conversion techniques.

Computer 112 (or event data processor 109) may then store the summary rate data 113 in data storage device 110. In an example embodiment, computer 112 (or event data processor 109) may compare the summary rate data 113 to one or more business patterns 111. Computer 112 (or event data processor 109) may then determine a state of a business 126 based on the comparison of summary rate data 113 to the business pattern(s) 111. In one example implementation, each business pattern 111 may be associated with one or more business states. For example, if the business summary rate data 113 is equal to a portion or subset of a previous summary rate data, or if summary rate data 113 for a business 126 meets one or more conditions or thresholds of a business pattern, then this may indicate that the business 126 is (likely) in a state (or states) associated with the business patterns.

Based on the business being in a state(s), or based on the comparison between the summary rate data 113 and one or more business patterns 111, computer 112 (or event data processor 109) may provide or output (e.g., to a user) a recommendation for one or more business actions to be performed. Alternatively, computer 112 (or event data processor 109) may perform a business action, or issue a command to another computer, e.g., computer 124, to perform the business action in response to the comparison or in response to the detected state(s) of the business 126. Computer 112 and/or event data processor 109 may perform a variety of other functions or tasks as described herein. A display 114 is coupled to computer 112 for displaying information, such as graphical representations of summary rate data 113, or other information.

For example, for a business event data 123 of sales or revenue, corresponding summary rate data 113 may include a revenue subtotal for each month over a six month period. Or, in another example, business events may include sales (database) records of individual sales of product X showing a date of sale, sales amount, name of customer, etc. In such a case, one example of summary rate data 113 may include the total sales of product X each day over a 60 day (or 2 month) period, thereby providing a summary of sales data for product X, including a rate/frequency (e.g., number) of sales per day over a 60 day period. In another example, summary rate data may include total sales of product X per week (or weekly sales of product X) over a 52 week (or 1 year) period.

Table 1 below illustrates an example of business event data 123 provided in a database that includes sales data for product X from Apr. 1, 2010-May 31, 2010. While database records or business event data 123 in Table 1 are shown for only a few days of this two month time period, the database storing the business events may typically include data or sales records (or business event data) for a much longer period of time, e.g., months or years. The example business event data in Table 1 includes individual sales records for product X, including the sale date, an identification of the product sold (product X in this example), the quantity of product sold to this customer for the specific day, the price per item/product, and an identification of the customer.

TABLE 1
Example Business Event Data including
daily sales data for product X

| Sale Date | Product | Quantity | Price/item | Customer |
|---|---|---|---|---|
| 4/1/2010 | X | 1 | $195 | A |
| 4/1/2010 | X | 2 | $195 | B |
| 4/1/2010 | X | 7 | $195 | C |
| 4/2/2010 | X | 10 | $190 | A |
| 4/2/2010 | X | 2 | $190 | D |
| 4/3/2010 | X | 11 | $198 | F |
| 4/3/2010 | X | 4 | $198 | C |
| . . . | . . . | . . . | . . . | . . . |
| 5/31/2010 | X | 4 | $205 | B |

TABLE 2
Example of summary rate data corresponding to Table 1

| Quantity (total for each day) | Date |
|---|---|
| 10 | 4/1/2010 |
| 12 | 4/2/2010 |
| 15 | 4/3/2010 |
| . . . | . . . |
| 19 | 5/31/2010 |

Computer 112 may transform this business event data 123 shown in Table 1 into corresponding summary rate data 113, e.g., by adding or summing the quantity of product X sold for each day. An example of the transformed (or resulting) summary rate data 113 is shown in Table 2. Thus, for example, the quantity information for 4/1/2010 of Table 1, which includes three sales records, may be transformed into corresponding summary rate data of Table 2 by adding the quantity of products sold on 4/1 (based on the 3 records for 4/1/2010), as 1+2+7=10. Thus, the three records for 4/1/2010 may be summarized (or provided as a subtotal) as 10, which is the total number of products sold on 4/1/2010, as shown in Table 2. Thus, the summary rate data 113 may summarize some aspect of the business event data, and may also provide rate or number (or quantity) information, such as a quantity of products sold for a specified period or sub-period (e.g., for each day in this example).

Tables 1 and 2 provide illustrative examples of business event data 123 and corresponding determined summary rate data 113, although this is merely one example, and many other forms and types of data may be used.

Table 3 illustrates another example of summary rate data. Total sales (total revenue) for each month, January-March, 2010, are provided for each of products A, B, C, D and E, and also a monthly total for all products A-E. For example, sales for product A were 140, 110 and 120 for January, February and March, respectively. Sales for product B were 150, 210 and 250 for January, February and March, respectively. Sales for product C were 60, 70 and 110 or January, February and March, respectively. Sales for product D were 70, 60 and 10 for January, February and March, respectively. Sales for product E were 30, 70 and 80 for January, February and March, respectively. Monthly totals are provided (which includes all products) for each of January, February and March.

TABLE 3
Another Example of Summary Rate Data

| Product | January, 2010 | February 2010 | March, 2010 |
|---|---|---|---|
| A | 140 | 110 | 120 |
| B | 150 | 210 | 250 |
| C | 60 | 70 | 110 |
| D | 70 | 60 | 10 |
| E | 30 | 70 | 80 |
| Total | 450 | 520 | 570 |

After computer 112 transforms business event data 123 into corresponding business summary rate data 113 (or determines summary rate data 113 based on business event data 123), computer 112 may compare the summary rate data 113 to one or more business patterns 111. Business patterns 111 may include, as examples, previous (or other) summary rate data (or a portion or subset thereof), conditions or thresholds, or other data indicating a business pattern or specific business activity.

For example, business pattern 1 may include: greater than 10% growth for sales, month over month, for two months in a row. Thus, the greater than 10% growth, month over month for 2 months in a row, is a condition. This condition also includes a threshold (10%).

Each business pattern may be associated with a state (or more than one state) of business 126, or a change in business state for business 126. Thus, when the summary rate data meets the conditions or thresholds, or otherwise satisfies, the business pattern, then this indicates that the business state(s) (or state of the business) associated with the business pattern, may be applied, or e.g., may be used to describe the current state (or likely current state) of the business 126. For example, business pattern 1 indicates or is associated with a business state of “rapid growth” for the specified product(s) for business 126. The product B of the business summary rate data 113 of Table 3 meets the business pattern 1, which may be associated with “rapid growth” for product B for business 126, for example.

Each business pattern may be associated with a state (or more than one state) of business 126, or a change in business state for business 126. A state of a business may identify a current state (or even its state at some point in the past), while a change in business state may include the current state as compared to a previous state (e.g., a 10% decrease in some value). In a number of cases, the current state may be described with reference to previous business states. Therefore, a current state and change in business state may be the same in some instances.

Computer 112 may then provide one or more recommended business actions (or may perform, either directly or indirectly, one or more business actions) in response to the comparison, e.g., in response to the detected state of the business. Thus, for example, a first business action may be associated with the business pattern 1. According to an illustrative example, a first business action of “purchase 25% additional raw materials for manufacture of product B” may be associated with the business pattern 1 and/or the first business state of “rapid growth” for product B. Thus, in response to detecting a business state of “rapid growth” (e.g., based on summary rate data for product B in Table 3 matching or meeting the business pattern 1), computer 112 may send a message to business operations computer 124 to purchase 25% additional raw materials for product B, or may recommend such action be taken. The recommendation (or action) to purchase 25% additional raw materials for product B may be performed to respond to the increased sales or increased demand for product B (with the expectation that production of product B may likely increase as well). Alternatively, the recommended business action associated with business pattern 1 may also include “increase production of product B by 10%.”

For example, to provide a recommendation, a message may be sent by computer 112 to another computer, or to a manager, or other entity, to provide notification of the current state (“rapid growth” for product B) of the business, the basis for the determination of the current state (e.g., identifying Table 3 or the data in Table 3 meeting the conditions of business pattern 1, and business pattern 1), and the associated recommended business action (e.g., “purchase 25% additional raw materials,”) so that these business actions may be performed to respond to this increased demand/growth for product B.

For example, computer 112 (or event data processor 109) may send a message to a person or manager in charge of materials purchase or procurement with instructions/suggestion to purchase additional material based on the analysis of summary rate data 113 (or business summary rate data 113). Thus, the business action (or recommended business action) may be designed to respond to or address the detected business state, for example.

Alternatively, instead of sending a recommendation for the business action, computer 112 may perform the business action indirectly, e.g., by sending the message to perform the business action (purchase 25% additional raw materials for product B) to business operations computer 124 of business 126. Business operations computer 124 may then perform the business action by increasing its order for raw materials for product B by 25%. Or, computer 112 may perform the business action directly by sending out a new or updated purchase order to one or more material suppliers or distributors, in order to purchase 25% additional raw materials.

Computer 112 or event data processor 109 may also send a message to a user or person or another computer to provide a notification that a particular (or identified) business pattern was met or satisfied by summary rate data, or may indicate that a business may (likely) be in a particular business state that is associated with a business pattern that has been met or satisfied.

Similarly, the summary rate data of Table 3 may be compared to other business patterns, such as business pattern 2. Business pattern 2 may include: greater than 15% growth for sales, month over month, for two months in a row. In this case, product B in Table 3 also matches the condition and the 15% threshold of business pattern 2, and may correspond to a business state of “rapid growth, 15%+.” As a result, computer 112 may perform (either directly or indirectly) the associated business action, or may send out a recommendation to perform the recommended business action of “purchase 30% additional raw materials for product B and increase production of product B by 15%.”

Also, in the event that the summary rate data meets or satisfies two (or multiple) business patterns, then the business action may be performed that is associated with the highest priority business pattern, which in this case, would be the business action for business pattern 2, since 15% growth is higher than 10% growth. Rules (e.g., based on priority) may be established in computer 112 that allow computer 112 to select between multiple business patterns and their associated business actions, where multiple business patterns are met or satisfied by summary rate data 113. In an example implementation, computer 112 may recommend or may perform business actions for only one or a subset of business patterns where the conditions of multiple business patterns are met by the summary rate data. In this example, the business pattern 2 may be considered higher priority than business pattern 1, and therefore, the business action for business pattern 2 may be performed if both business patterns are met. Alternatively, or in another illustrative example implementation, all of the business actions may be performed where multiple business patterns are met by summary rate data.

According to another example, a business pattern 3 may include more than a 50% decrease in sales of a product, month over month. In this example, within the summary rate data of Table 3, the March sales data for product D drops from 60 to 10 (as compared to February sales data for product D). This business behavior may be considered an anomaly or very unusual behavior for business 126. While this can happen (a 50% decrease in monthly sales), such business behavior may typically be an indication of some problems that have occurred within business 126 for this product. For example, such a large drop in sales in such a short period of time may be a sign of a problem, failure or breakdown within any number of areas, such as failure of IT or website services to receive orders, failure in manufacturing to manufacture products in a timely manner, or a failure or breakdown in materials procurement to obtain sufficient quantities of raw materials (as some illustrative examples).

The business state associated with business pattern 3 may be, for example: “50% decrease in monthly sales for product D.” Thus, in this example, a business action or recommended business action associated with business pattern 3 may be to “perform business audit of sales and manufacturing operations for product D.” Therefore, computer 112 may either perform the business audit of product D directly, or may perform the audit indirectly by sending a message to business operations computer 124 to “perform business audit of sales and manufacturing operations for product D.” Or, computer 112 may send or issue a recommendation to a user or manager or other computer recommending or suggesting that such business action be performed. For example, the recommendation sent to a user or other computer may identify the recommended business action, and may also identify some background information, such as the summary rate table (which met the business pattern), the business pattern (business pattern 3) that triggered the business action and the associated business state (“50% decrease in monthly sales for product D” in this example), which may be determined or detected based on the comparison of the summary rate table to the business pattern. A business action may be associated with a business state or business pattern, wherein the associated business action may (or should) be performed when the summary rate data meets or satisfies the business pattern, for example.

Computer 112, or event data processor 109, may also establish or create, e.g., by storing in memory or data storage 110, a new business pattern, a business state, and a business action (e.g., to be performed or recommended) associated with the new business pattern. For example, a user (or a computer 112 and/or event data processor 109) may detect a certain business behavior. For example, computer 112 and/or event data processor 109 may receive and process business event data (e.g., some past business event data), and determine summary rate data based on this business event data (e.g., by performing a mathematical transformation of the business event data). The computer or event data processor 109, and/or a user or person, may than evaluate or analyze the summary rate data to determine one or more business patterns of interest. For example, daily number of sales for product X (summary rate data) may be calculated for each day of a 14-day period based on the business event data (e.g., based on sales data over the 14-day period). The delta or difference in sales numbers between each day may be calculated, e.g., +1 (indicating an increase of 1, compared to the previous day), +3, +4, +7, −2 (indicating a decrease of 2 compared to the previous day), . . . 0, for the 14-day period. The delta or difference for each of the 14 days may then be analyzed or evaluated to determine or identify one or more new business patterns. For example, a first new business pattern may be identified as at least a 1% increase in sales each day of the 14-day period, or 10 consecutive days with an increase in sales, or a decrease in sales any one day that exceeds Y (e.g., a decrease in daily sales that exceeds 4 for any day (any sub-period) within the 14-day period, for example).

Once a new business pattern has been identified (such as, for example, a sales decrease that is greater than X for any day as compared to the previous day), this new business pattern may be stored in memory or within data storage 110. A business state associated with the new business pattern and a business action associated with the new business pattern may also be stored in data storage 110. Computer 112 and/or event data processor 109 may thereafter analyze or process other business event data to detect or identify when the new business pattern is met or satisfied by the other business event data. For example, business event data may be obtained and transformed to summary rate data, and the summary rate data may be evaluated (e.g., compared to the new business pattern) to determine if the new business pattern is met by the summary rate data (e.g., to determine if the summary rate data matches the conditions of the new business pattern).

If the summary rate data matches the new business pattern (e.g., satisfies the one or more conditions or thresholds of the new business pattern), then a message may be sent to another person or user or to a computer, providing a notification that the new business pattern was met or satisfied by business event data. The message may include or identify, for example, one or more of the new business pattern, the business event data that matched the new business pattern, the business state associated with the new business pattern, and the (e.g., recommended) business action to be performed that is associated with the new business pattern. A computer, such as business operations computer 124, upon receipt of the message from computer 112 or event data processor 109, may then perform the recommended business action according to an example implementation.

The message may also include (or may provide a link to, address of, or resource identifier for), for example, a graphical representation of the summary rate data with a graphical indication of a portion of the summary rate data that matched the new business pattern. In an example implementation, the graphical indication may include, e.g., a circle or other marking provided to identify a portion of the graphical representation or graph of the summary rate data, where the marking may highlight or identify the summary rate data for the sub-period on the graph that met the new business pattern, e.g., exceeded a threshold or met a condition, such as sales data that decreased more than 4 as compared to the previous day.

As another example, a user may manually (or with the assistance of a computer) detect a 50%+ drop in monthly sales of a product(s). Investigations may reveal, for example, that such a large decrease in sales typically results from problems in manufacturing or insufficient raw materials, which may delay manufacturing for products. If the products are not available, then sales may typically be rejected or delayed, and/or revenue/payment is delayed for sale of such products. A business action, e.g., computer 124 checking supplies of raw materials for manufacture of the product and confirm that materials supply exceeds a threshold (e.g., supply exceeds 2 months supply), may be performed, or may be recommended when this business pattern is detected. Therefore, this new business pattern and the recommended associated business action may be stored in data storage 110. Thereafter, computer 112 or event data processor 109 may obtain other business event data, generate or determine summary rate data based on the business event data, and compare the summary rate data and/or the business event data to the conditions or thresholds of this new business pattern. If the conditions or thresholds (e.g., a 50%+ drop in monthly sales of a product) of this new business pattern are met, then a message may be sent, e.g., to computer 124, to provide a notification that the business pattern was met, and computer 124 (or a user) may then perform the associated business action, according to an example implementation.

For example, for business 126, while a 30% decrease or 30% variation in monthly sales was fairly common, a 50%+ decrease in monthly sales was very unusual, and typically resulted from the manufacturing or supply chain problems noted above. Therefore, according to this illustrative example, computer 112 may create and store in memory or data storage 110: a business pattern 3 and an associated business state and an associated business action for the business pattern 3. Therefore, after such creation and storage of business pattern 3, rather than relying on a user to manually detect the 50%+ decrease in sales, computer 112, or event data processor 109, may now automatically detect such business behavior based on the newly created business pattern 3 (e.g., by comparison of summary rate data every month to the business pattern 3). If the newly created business pattern 3 is met by summary rate data, computer 112 may detect this business behavior (based on comparison of summary rate data to business pattern 3) and sends a message to indicate the recommended business action (or may directly or indirectly perform the associated business action) associated with business pattern 3, and may also identify the associated business state for business 126.

According to another example implementation, a new business pattern may be created and stored in memory in response to summary rate data not meeting or matching one or more existing business patterns. For example, summary rate data may be compared to one or more existing business patterns. In some cases, the summary rate data may not match or meet the conditions of any of the one or more existing business patterns. Rather, for example, the (non-matching) summary rate data may reflect a new business pattern. Therefore, a new business pattern may be created and stored in data storage or memory that reflects, or would be met by the (non-matching) summary rate data. In other words, for example, the new business pattern may include one or more conditions or thresholds that would be met by the summary rate data that did not meet or match the other existing business patterns. In this manner, comparison results from the comparison of summary rate data to one or more existing business patterns may be used to generate or create one or more new business patterns.

The above examples describe that, in example implementations, summary rate data may be determined based on a transformation of business event data. However, in a more general case, transformed business event data may be obtained by performing a transformation of the business event data or by performing a mathematical function based on the business event data. For example, transformed business event data may be obtained or determined by performing a Fourier transform, statistical analysis or statistical function based on the (or statistical transformation of) business event data, e.g., by calculating an average, mean, standard deviation, maximum, minimum or other statistical function. A statistical function is just one example of how transformed business event data may be obtained by performing a transform or mathematical function on the business event data. Summary rate data is another example of transformed business event data. Thus, two examples of determining transformed business event data may include: 1) performing a statistical function (or other mathematical transform or mathematical function) based on the business event data to obtain transformed business event data (e.g., by calculating a mean, average, standard deviation, maximum, or minimum of business event data), and 2) determining summary rate data based on performing a transform of the business event data. These are merely two examples, and other types of transformations may be used to determine transformed business event data.

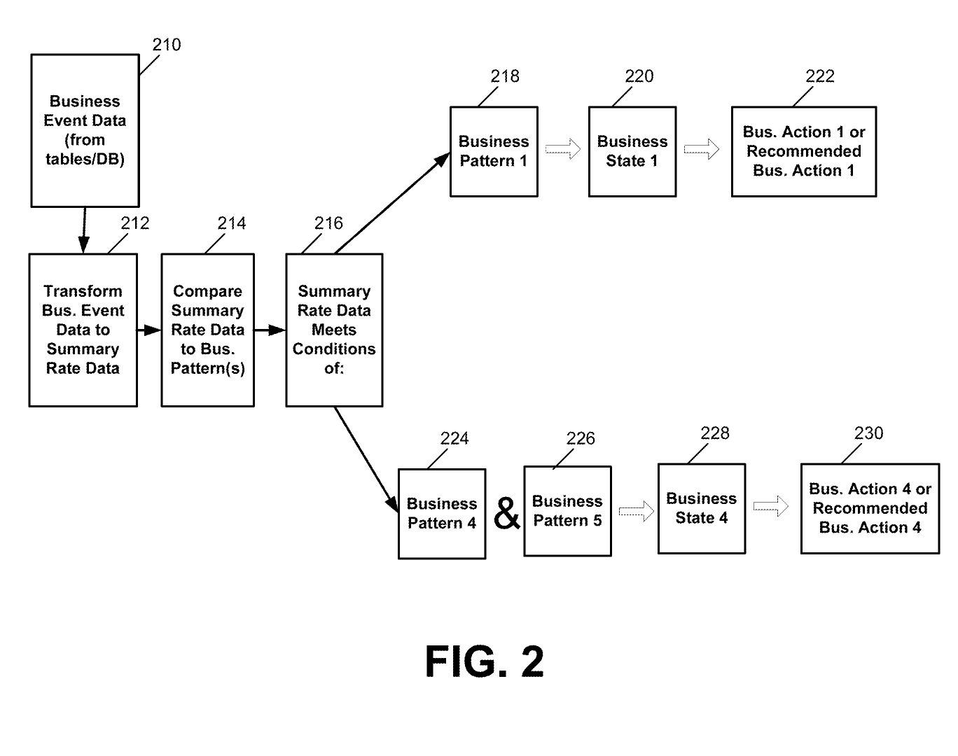

FIG. 2 is a block diagram illustrating the processing of business event data to determine business state according to an example implementation. Although not shown, one or more business patterns (e.g., business patterns 1, 2, 3, 4, . . . ) may be stored in memory or data storage 110. For example, a user, e.g., by review or analysis of business event data or summary rate data, may initially detect one or more business patterns, and may then store the business patterns (the conditions or thresholds for such business patterns) in data storage 110. These stored business patterns may allow computer 112 or event data processor 109 to automatically detect when the business behavior matches the business pattern, e.g., when the summary rate data or business event data matches or meets the conditions or thresholds of one or more of the business patterns.

At 210, business event data is obtained or received by computer 112 from one or more databases, or from one or more tables within a database. At 212, computer 112 transforms the business event data 123 to corresponding summary rate data 113. In other words, computer 112 determines summary rate data 113 based on business event data 123. At 214, computer 112 compares the summary rate data 113 (or business summary rate data) to one or more business patterns 111. For example, if summary rate data 113 meets conditions of business pattern 1, then this may correspond to business 126 being in the business state 1, and the associated business action 1 may be performed (directly or indirectly by computer 112), or may be recommended by computer 112.

Similarly, summary rate data may be compared to other business patterns, including business pattern 4 and business pattern 5. Also, business patterns may be logically combined, e.g., with Boolean operators, such as AND (&), OR, NOR, and NAND. For example, as shown in FIG. 2, summary rate data may be compared to both business pattern 4 (block 224) and business pattern 5 (block 226). Business state 4 is present or describes current state of business 126 (block 228) and business action 4 is performed or recommended (block 230) if summary rate data 113 meets or satisfies both business pattern 4 (224) AND (&) business pattern 5 (226), as shown in FIG. 2. For example, business pattern 4 may include: sales less than 80 for three months in a row. Business pattern 5 may include: sales in a current month less than 90. In this case, both business patterns 4 and 5 are met by product D, where current month is March (in this example). Product E meets business pattern 5, but does not meet business pattern 4. Therefore, in this example, business action 4 may (or should) be performed with respect to product D, or may be recommended with respect to product D. For example, business state 4 may be: “Low demand for product D.” Business action 4 may be to “Evaluate sales and demand for product D, and consider dropping product D.” Or, as another example, business action 4 may include: “Decrease production of product D by 10%.”

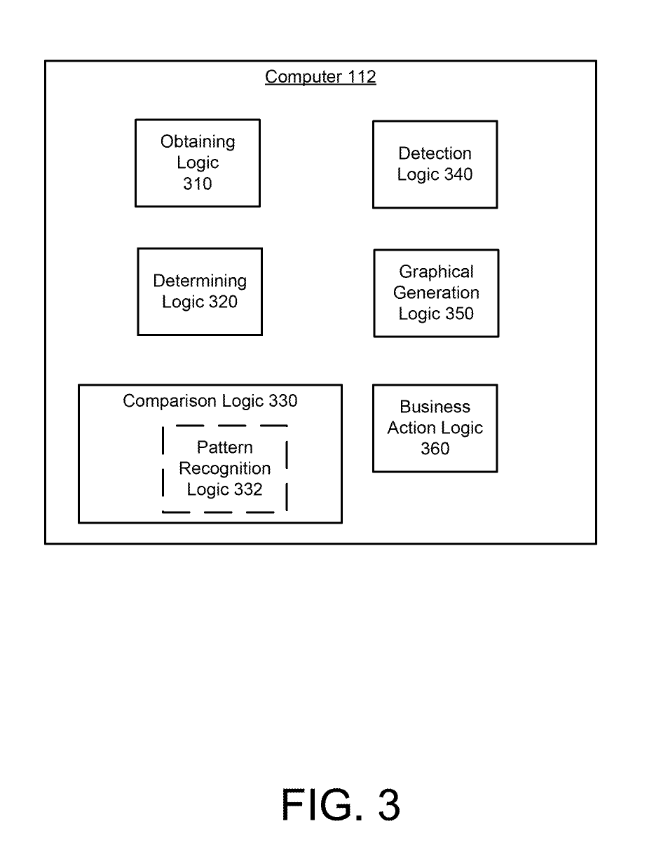

FIG. 3 is a functional block diagram of computer 112 according to an example implementation. Computer 112 may include a number of different functional blocks. Obtaining logic 310 is configured to obtain business event data for a business, the business event data associated with one or more items for sale by or sold by the business 126. Determining logic 320 is configured to determine summary rate data based on the business event data. Comparison logic 330 is configured to compare the summary rate data to one or more business patterns.

Comparison logic 330 may include, for example, pattern recognition logic 332 to recognize one or more patterns. Detection logic 340 is configured to detect a state of the business based on the comparison of the summary rate data to one or more of the patterns. Graphical generation logic 350 is configured to generate a graphical representation of the summary rate data for display. And, business action logic 360 is configured to perform a business action related to materials for or manufacturing of one or more of the items for sale in response to the detected state of the business. Business action logic 360 may actually perform the business action (e.g., order 25% more materials), or may perform the business action indirectly, e.g., by sending a message to another computer, such as computer 124, which may perform the business action as instruction by computer 112.

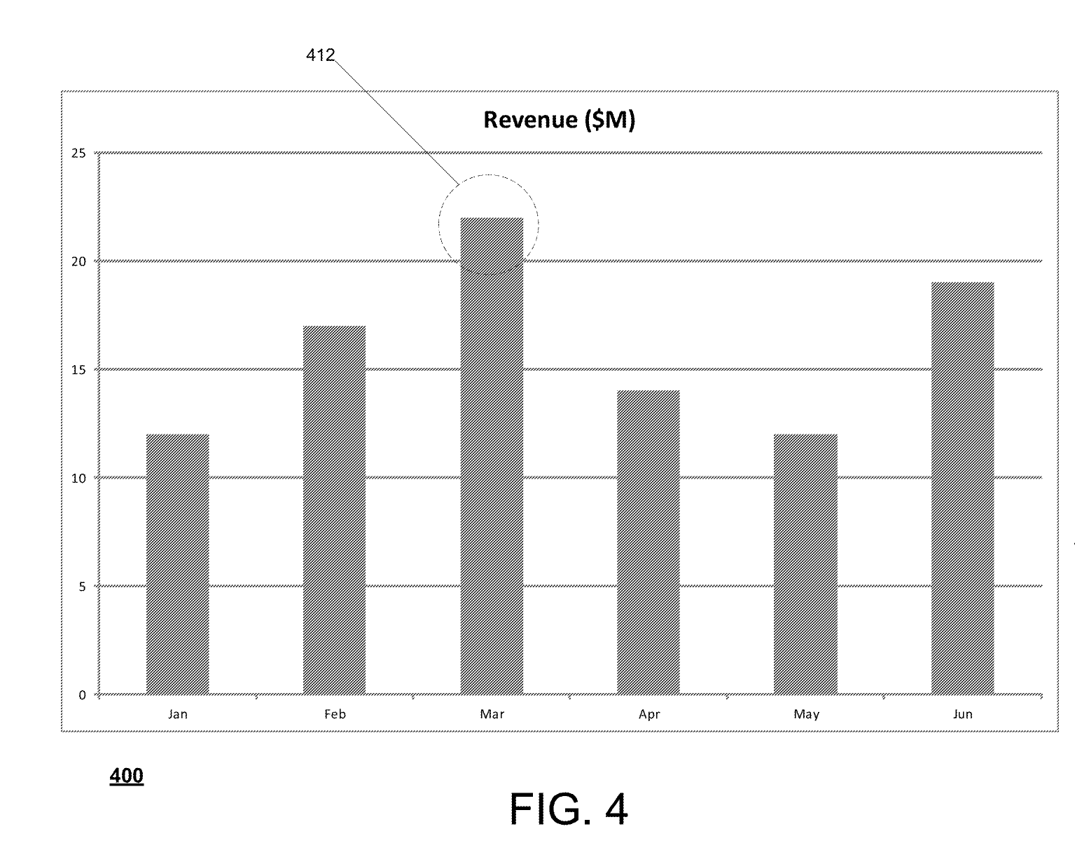

FIG. 4 is a diagram illustrating an example graphical representation 400 of summary rate data. In this example, summary rate data, which includes monthly revenue for months January (12), February (17), March (22), April (14), May (12) and June (19), are shown as bar graphs, and may be generated and displayed on display 114 by computer 112. This bar graph is merely one illustrative example of a graphical representation of summary rate data, and other graphical representations may be used. The graphical representation 400 in FIG. 4 may also include a marking 412 (or indication) that identifies a portion of the graphical representation or graph of the summary rate data that met the new business pattern, e.g., identified a portion of the graph that exceeded a threshold or met a condition of the business pattern. In this example, the upper portion of the bar for the revenue for the month of March is circled or identified by marking 412 because the March revenue exceeded 20, which was a condition or threshold for the business pattern (e.g., graphical representation 400 may have been generated when the summary rate data met the business pattern, e.g., when monthly revenue exceeded 20).

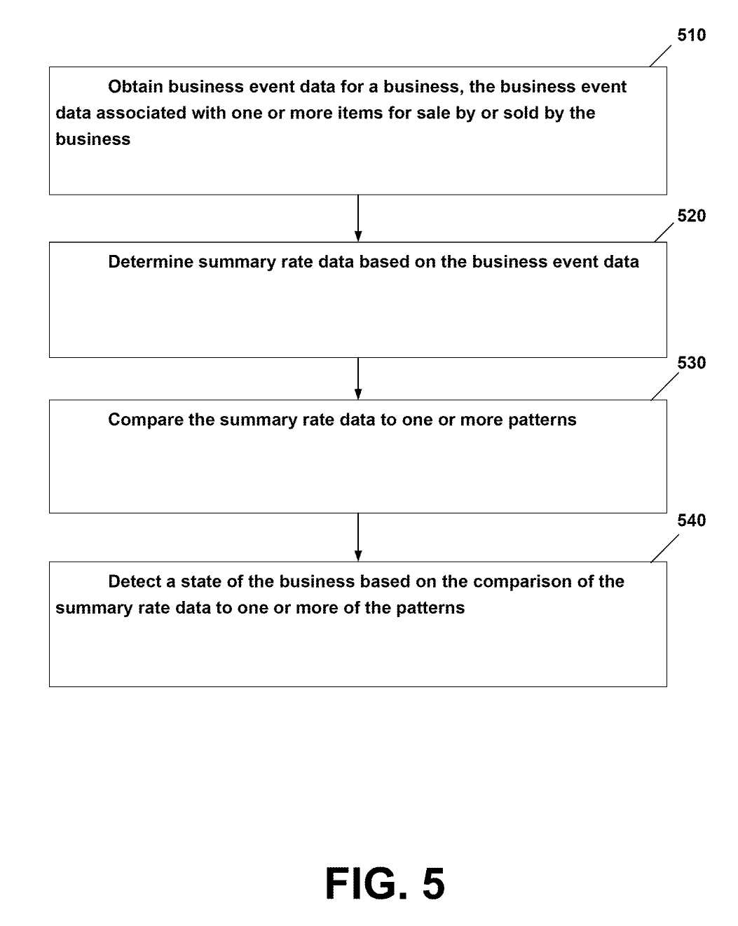

FIG. 5 is a flow chart illustrating operation of computer 112 according to an example implementation. At 510, business event data is obtained for a business, the business event data associated with one or more items for sale by or sold by the business. At 520, summary rate data is determined based on the business event data. At 530, the summary rate data is compared to one or more business patterns. For example, it may be determined that summary rate data meets conditions of a business pattern. At 540, a state of the business is detected based on the comparison of the summary rate data to one or more of the business patterns. For example, a business state (or state of business 126) may be detected that is associated with the matching business pattern.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program that might implement the techniques mentioned above might be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a computer-readable storage medium and including executable code that, when executed, is configured to cause at least one data processing apparatus to:
obtain business event data for a business, the business event data associated with one or more items for sale by or sold by the business;
determine summary rate data based on the business event data;
compare the summary rate data to one or more business patterns; and
detect a state of the business based on the comparison of the summary rate data to one or more of the business patterns.

2. The computer program product of claim 1 wherein the executable code causing the data processing apparatus to detect comprises executable code causing the data processing apparatus to detect a state of the business based on a match of the summary rate data to one or more of the business patterns.

3. The computer program product of claim 1 wherein the executable code causing the data processing apparatus to detect comprises executable code causing the data processing apparatus to detect a change in a state of the business based on a match of the summary rate data to one or more of the business patterns.

4. The computer program product of claim 1 wherein the executable code causing the data processing apparatus to obtain business event data comprises executable code causing the data processing apparatus to read or receive the business event data for the business from one or more databases.

5. The computer program product of claim 1 wherein the executable code causing the data processing apparatus to determine comprises executable code causing the data processing apparatus to transform the business event data for the business that describes two or more business events to summary rate data that provides a summary of the business event data to identify a rate or frequency of occurrence for two or more business events over one or more periods of time.

6. The computer program product of claim 1 wherein the business event data comprises data describing a plurality of business events that occurred for the business, and wherein the summary rate data summarizes the business event data over a period of time.

7. The computer program product of claim 1 wherein the executable code further causes the data processing apparatus to generate a graphical representation of the summary rate data for display.

8. The computer program product of claim 1 wherein each of the one or more patterns comprises one or more conditions, and wherein the executable code causing the data processing apparatus to compare the summary rate data to one or more business patterns comprises executable code causing the data processing apparatus to determine whether the summary rate data meets the one or more conditions.

9. The computer program product of claim 8 wherein the executable code causing the data processing apparatus to determine whether the summary rate data meets the one or more conditions comprises executable code causing the data processing apparatus to determine whether the summary rate data exceeds one or more thresholds.

10. The computer program product of claim 1 wherein the summary rate data is for a period of time, and the one or more patterns each comprise summary rate data for a previous period of time.

11. The computer program product of claim 1 wherein the executable code further causes the data processing apparatus to provide one or more recommended business actions in response to the detected state of the business.

12. The computer program product of claim 1 wherein the executable code further causes the data processing apparatus to perform a business action in response to the detected state of the business.

13. The computer program product of claim 1:
wherein the executable code causing the data processing apparatus to detect comprises executable code causing the data processing apparatus to detect a change in a state of the business based on the comparison of the summary rate data to one or more of the business patterns; and
wherein the executable code further causes the data processing apparatus to perform a business action in response to the detected change in a state of the business.

14. The computer program product of claim 1 and wherein the executable code further causes the data processing apparatus to store in a memory one or more of the business patterns and a business action associated with each business pattern.

15. The computer program product of claim 1 wherein the executable code further causes the data processing apparatus to:
determine, based on the comparison, that the summary rate data does not meet conditions associated with the one or more business patterns; and
create, in response to the determining and based on the summary rate data, a new business pattern that includes one or more conditions that would be met by the summary rate data; and
store the new business pattern.

16. A computer implemented method comprising:
obtaining business event data for a business, the business event data associated with one or more items for sale by or sold by the business;
determining summary rate data based on the business event data;
comparing the summary rate data to one or more business patterns; and
detecting a state of the business based on the comparison of the summary rate data to one or more of the business patterns.

17. The computer implemented method of claim 16 wherein the detecting comprises detecting a state of the business, or a change in the state of the business, based on a match of the summary rate data to one or more of the business patterns.

18. The computer implemented method of claim 16 wherein the determining comprises transforming the business event data for the business that describes two or more business events to summary rate data that provides a summary of the business event data to identify a rate or frequency of occurrence for two or more business events over one or more periods of time.

19. The computer implemented method of claim 16, wherein the one or more patterns comprise one or more conditions or thresholds, and wherein the comparing comprises determine whether the summary rate data meets the one or more conditions or thresholds.

20. An apparatus comprising:
obtaining logic configured to obtain business event data for a business, the business event data associated with one or more items for sale by or sold by the business;
determining logic configured to determine summary rate data based on the business event data;
comparison logic configured to compare the summary rate data to one or more business patterns; and
detection logic configured to detect a state of the business based on the comparison of the summary rate data to one or more of the business patterns.

21. The apparatus of claim 20 and further comprising:
graphical generation logic configured to generate a graphical representation of the summary rate data for display; and
business action logic configured to perform a business action related to materials for or manufacturing of one or more of the items for sale in response to the detected state of the business.
